(19) United States
(12) Patent Application Publication
(10) Pub. No.: US 2020/0306114 A1
(43) Pub. Date: Oct. 1, 2020

(54) Adjustable Anti-Tipper for Wheelchairs

(71) Applicants: Kelly Cook, (US); Brooke Hostetter, (US)

(72) Inventors: Kelly Cook, Clinton, NJ (US); Brooke Hostetter, Oxford, PA (US)

(73) Assignees: Kelly Cook, Clinton, NJ (US); Brooke Hostetter, Oxford, PA (US)

(21) Appl. No.: 16/829,427

(22) Filed: Mar. 25, 2020

Related U.S. Application Data
(60) Provisional application No. 62/823,090, filed on Mar. 25, 2019.

(51) Int. Cl. A61G 5/10

(52) U.S. Cl. CPC A61G 5/1089

(57) ABSTRACT

The inventions disclosed herein relate to wheelchair anti-tippers that are adjustable. For example, adjustable wheelchair anti-tippers can allow the wheelchair pusher (e.g., caretaker) to move the anti-tippers up and down, e.g., to prevent obstruction of the walking path. The wheelchair anti-tippers disclosed herein are adjusted, e.g., by moving a lever. The wheelchair anti-tippers disclosed herein can reduce the need for a wheelchair pusher to bend over multiple times to adjust the anti-tippers, which can be ergonomically beneficial to the wheelchair pusher. If wheelchair tips there is a high chance the occupant will become injured, an anti-tipper can prevent this and assist in keeping the occupant safe.

### BACKGROUND OF THE INVENTION

Wheelchair anti-tippers are generally difficult to work with. Traditionally, wheelchair anti-tippers comprise permanent non-moving fixture(s) fastened to the wheelchair which create an obstruction for caretakers due to their positioning and permanent attachment. The permeant fixed down position typically cause caretakers to kick the anti-tippers. Current anti-tippers on the market do not adjust so as to clear a path for caretakers or require the caretaker to bend over and unclip the anti-tippers out of the way. An adjustable anti-tipper is an ergonomic approach for caretakers to safely maneuver wheelchairs. Adjustable anti-tippers are a desirable product as they ensure the safety of individual pushing a wheelchair.

### SUMMARY OF THE INVENTION

In some embodiments, the invention is an adjustable wheelchair anti-tipper comprising: a housing that secures said wheelchair anti-tipper to a frame of a wheelchair and a lever to adjust said wheelchair anti-tipper. In one aspect, the anti-tipper is comprised of metal. In one aspect, the anti-tipper is composed of steel. In one aspect, the anti-tipper is comprised of aluminum.

In some embodiments, the anti-tipper is adjusted by retracting an anti-tipper arm up using a lever. In one aspect, the lever is used to move the anti-tipper up and down.

In some embodiments, the anti-tipper is permanently affixed to the rear of a wheelchair.

In some embodiments, the anti-tipper is retracted up and outside the path of a pusher's movement. In some embodiments, the adjustable wheelchair anti-tipper further comprises a connecting component between said wheelchair anti-tipper and a lever.

In some embodiments, the system creates unobstructed space for walking while pushing the wheelchair and provides an anti-tipping mechanism preventing the wheelchair from tipping.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 is an exemplary illustration of the anti-tippers. FIG. 1A is an exemplary illustration of the anti-tippers in a down position. FIG. 1B is an exemplary illustration of the anti-tippers in an up position.

FIG. 2 is an exemplary illustration of the anti-tippers on a wheelchair. FIG. 2A is an exemplary illustration of the anti-tippers in an upward position affixed to the rear of a wheelchair.

FIG. 2B is an exemplary illustration of the anti-tippers in a downward position affixed to the rear of a wheelchair.

### DETAILED DESCRIPTION OF THE INVENTION

A wheelchair is a mobility device that generally has one wheel affixed to either side allowing the user to be transported without requiring the user to walk. In some embodiments a wheelchair is power driven, allowing the user to singularly control the movements. In some embodiments a wheelchair is manually operated. Manually operated wheelchairs can be controlled by the user or a separate person acting as the wheelchair pusher. Wheelchairs can have anti-tippers. Anti-tippers regulate the amount of allowable tilt in one direction from a wheelchair.

This embodiment is intended to fit on a wide variety of wheelchair models. Some non-limiting examples of wheelchair models include: Invacare Tracer SX5, Viper Deluxe Lightweight Dual Axle, Sunrise Medical Breezy EC 2000, Karman Healthcare S-Ergo Ultra Lightweight Ergonomic, and Drive Medical Cruiser III. One skilled in the art will recognize that there are many types of wheelchairs that could benefit from an adjustable anti-tipper.

Adjustable anti-tippers can be affixed to a wheelchair. Adjustable anti-tippers can be affixed by including a housing that is secured to the frame (i.e. support structure on the back of a wheelchair).

In some embodiments, anti-tippers can be affixed to the rear or the front of a wheelchair. In preferred embodiments, wheelchair adjustable anti-tippers can be affixed to the rear of a wheelchair, with an adjustable wheelchair anti-tipper for each of the wheelchair's back wheels. An adjustable wheelchair anti-tipper can be permanently fixed to the frame. An adjustable wheelchair anti-tipper can be adjusted (e.g. can be moved up and down). Additionally, the anti-tipper can have a length adjustment (e.g. to increase or decrease the length of the anti-tipper to allow for customization of the space between the floor and the downward position of the anti-tipper).

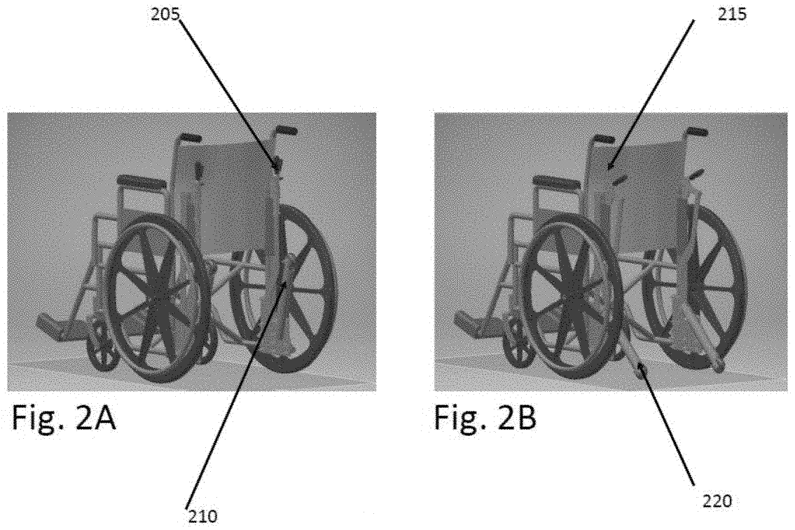

In some embodiments, the wheelchair anti-tipper is adjustable to reduce the interference with a person who is pushing the wheelchair (e.g. reducing the likelihood that a wheelchair pusher would trip). The adjustable feature can allow the wheelchair pusher to safely guide the wheelchair without a permanent walking obstruction. Adjustable anti-tippers create a space for a clear walking path. FIG. 2(a) depicts the anti-tippers attached to a wheelchair in the upright position. This position ensures the support arm does not create an obstruction for the wheelchair pusher while walking.

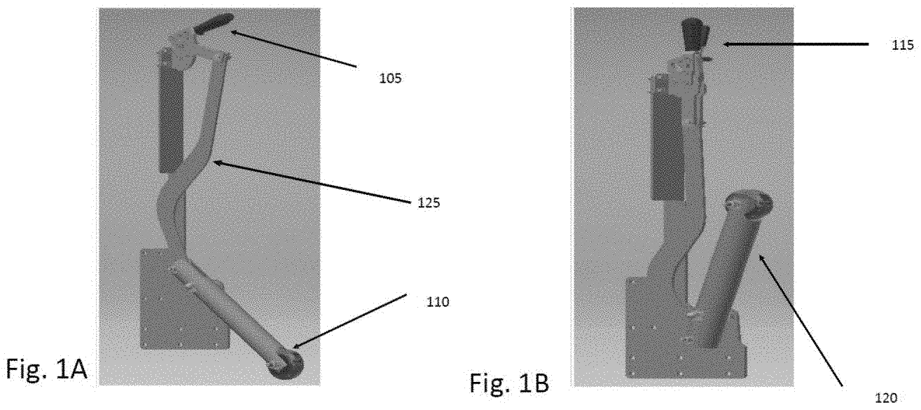

The adjustable anti-tippers include levers (115) allowing for adjustability. FIG. 1(a) depicts the support arm in an operable position. The levers (105) are in a downward position signaling the adjustable anti-tipper has rotated out of the upward position as shown in FIG. 1(b).

Anti-tippers can be made out of a variety of materials. The material can be a strong material. In some embodiments anti-tippers are comprised of metal. In some embodiments, the material can be a hollow metal tubing. Some non-limiting examples of metal used in an anti-tipper construction can include: aluminum, steel, powder coated steel, heavy gauge chrome plated steel and any combination thereof. In some embodiments, the strong material can be comprised of hard plastic.

In some embodiments the bottom portion of the anti-tippers which come into contact with the floor are either wheels or a flat grippy material. The flat grippy material acts as a bumper, reducing slipping on smooth surfaces. The flat grippy material can be made by a variety of substances. Some non-limiting examples of grippy materials include rubber, plastic, and silicone.

The adjustable anti-tippers have levers (105) below the handles of the wheelchair which adjust the position of the anti-tippers (110), through the use of a connecting component (125) between the levers (105) of the anti-tipper and the anti-tippers (110). In an exemplary embodiment, this connecting component (125) may have a curved portion which allows the anti-tipper (110) more clearance behind the wheelchair when it is in the upright position—as seen in FIG. 1B and FIG. 2A. This connecting component (125), may be comprised of a strong material, such as: metal, hollow metal tubing, aluminum, steel, powder coated steel, heavy gauge chrome plated steel and any combination thereof. In other embodiments, the strong material for the connecting component (125), may be comprised of a hard plastic. The lever (105) is made of metal coated in rubber.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

What is claimed is:

1. An adjustable wheelchair anti-tipper comprising: a housing that secures said wheelchair anti-tipper to a frame of a wheelchair and a lever to adjust said wheelchair anti-tipper.

2. The adjustable wheelchair anti-tipper of claim 1, wherein said anti-tipper is comprised of metal.

3. The adjustable wheelchair anti-tipper of claim 1, wherein said anti-tipper is comprised of steel.

4. The adjustable wheelchair anti-tipper of claim 1, wherein said anti-tipper is comprised of aluminum.

5. The adjustable wheelchair anti-tipper of claim 1, wherein said anti-tipper is adjusted by retracting an anti-tipper arm up using a lever.

6. The adjustable wheelchair anti-tipper of claim 1, wherein said lever is used to move the anti-tipper up and down.

7. The adjustable wheelchair anti-tipper of claim 1, wherein said anti-tipper is permanently affixed to the rear of a wheelchair.

8. The adjustable wheelchair anti-tipper of claim 1, wherein said anti-tipper is retracted up and outside the path of a pusher's movement.

9. The adjustable wheelchair anti-tipper of claim 1, further comprising a connecting component between said wheelchair anti-tipper and a lever.

10. A system that creates unobstructed space for walking while pushing the wheelchair and provides an anti-tipping mechanism preventing the wheelchair from tipping.
